(19) United States
(12) Patent Application Publication
(10) Pub. No.: US 2006/0023248 A1
(43) Pub. Date: Feb. 2, 2006

(54) Multifunctional peripheral

(76) Inventors: Curtis Reese, Boise, ID (US); Brett A. Green, Meridian, ID (US); John R. Hatten, Boise, ID (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/902,896

(22) Filed: Jul. 30, 2004

(51) Int. Cl. G06F 15/00

(52) U.S. Cl. 358/1.15

(57) ABSTRACT

A multifunctional peripheral (MFP) including a scanner mechanism can deliver a report to a user. The MFP can generate, by use of the scanner mechanism, electronic data that describes an image of a receipt, where the receipt indicates a credit to a credit card account. The MFP can automatically deliver a report of the credit to a user.

### BACKGROUND OF THE INVENTION

A credit card holder will typically receive a credit card statement at the end of a pre-determined billing cycle. The statement typically includes a list of those transactions that have occurred between the billing cycle start date (e.g., the first day of a particular month) and the billing cycle end date (e.g., the last day of the month).

These listed transactions may include both charges and credits to the credit card account. For example, suppose a merchant applied a credit to the credit card account during the billing cycle. In theory, such a credit would (or at least should) appear on the statement for that billing cycle.

A credit card holder may wish to reconcile such credits that he/she believes should be listed on his/her credit card statement. This can be a difficult task especially if multiple credits have been applied by multiple merchants to his/her credit card account over a particular billing cycle. Improved ways are needed for a credit card holder to track and reconcile credits to his/her credit card account.

### DESCRIPTION OF THE FIGURES

FIG. 1 shows a computing system according to one example embodiment of the invention;

FIG. 2A shows a flow chart for describing how a user may operate a host computer to initially configure an MFP;

FIG. 2B shows a graphical user interface that can be used to configure an MFP;

FIGS. 3A-3C illustrates one non-limiting example of how a user may use the MFP to create a record of a credit receipt;

FIG. 4 shows a flow chart that depicts how the MFP may operate to deliver a credit report for a credit card account.

### DESCRIPTION

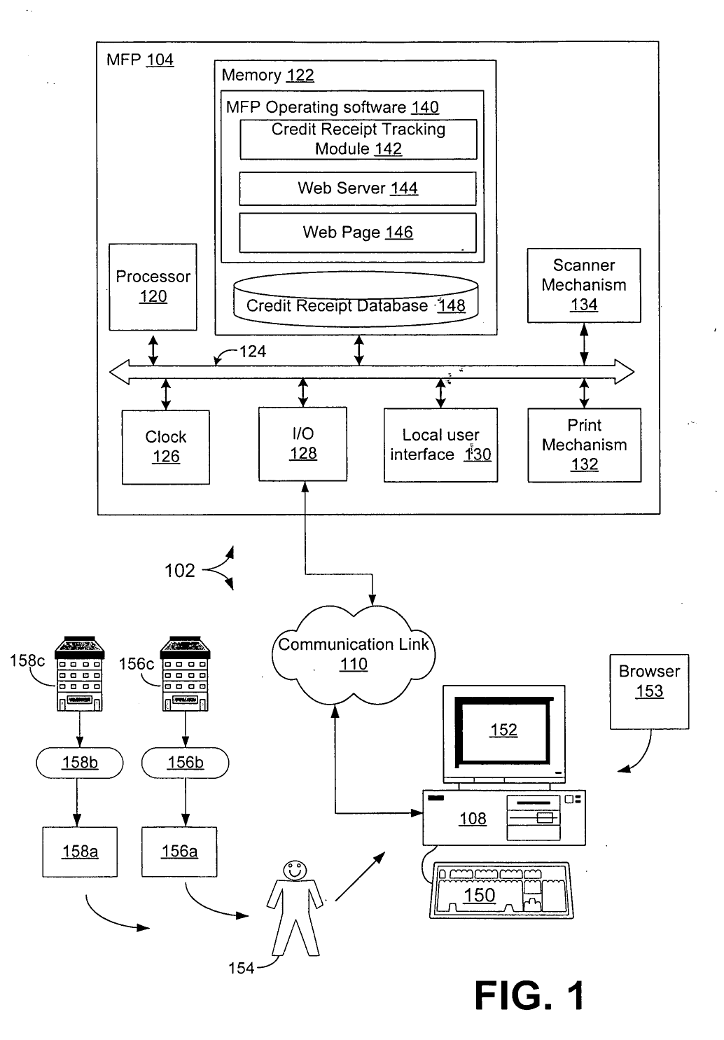

With reference to FIG. 1, shown is a computing system 102 according to one example embodiment of the invention. The computing system 102 includes a multi-function peripheral (MFP) 104 and a host computer 108. The MFP 104 and the host computer 108 are each coupled to a communication link 110 and are in data communication with each other via the communication link 110. The communication link 110 may be, for example, a local area network, a data communication cable, etc.

The host computer 108 may be a personal computer that includes a user input device 150 (e.g., keyboard and/or mouse, etc) and a display device 152 (e.g., a CRT, Flat panel display, etc). As indicated, the host computer 108 runs a Web Browser 153.

For illustration purposes, we will assume in the discussion that follows that a user 154 typically operates the host computer 108 and that this user holds a first credit card 156a and a second credit card 158a. The first credit card 156a is used by the user 154 to place charges and credits to a first credit card account 156b and was issued to the user 154 by a first credit card provider 156c. The second credit card 158a is used by the user 154 to place charges and credits to a second credit card account 158b and was issued to the user 154 by a second credit card provider 158c. It is noted that both the first credit card 156a and the second credit card 158a adhere to the ANSI Standard X4.13-1983 numbering system. This standard is incorporated herein by reference.

The MFP 104 includes a control system to implement and control print and scan functions as well as to provide a “credit receipt tracking service” that is described below. The control system includes a processor 120 and a memory 122, both of which are coupled to a local interface 124. The local interface 124 may be a data bus with an accompanying control bus as known by those with ordinary skill in the art.

The MFP 104 also includes a real-time clock 126, an input-output (I/O) port 128, a local user interface (local UI) 130, a print mechanism 132 and a scanner mechanism 134. Some or all of these components may also be connected to the local interface 124.

The real-time clock 126 enables the MFP 104 to track the current date and time. In some implementations, the real-time clock 126 is powered by a battery (not shown) and continues to function even when the main power supply of the MFP 104 is turned off. The I/O port 128 may include a physical and/or a wireless connection port as well as appropriate buffer and other circuitry so as to enable the MFP 104 to connect to and communicate data over the communication link 110.

The local UI 130 generally enables a walk-up user to provide input to the MFP 104 and also enables the MFP 104 to display information, such as a graphical user interface (GUI), back to the user. Thus, for example, the local UI 130 may include one or more user input devices (e.g., a keypad, touch pad, touch screen, mouse, joystick, or one or more push buttons, etc) and one or more display devices (e.g., a cathode ray tube (CRT), a liquid crystal display screen, a gas plasma-based flat panel display, indicator lights, light emitting diodes, etc).

The printing mechanism 132 enables the MFP 104 to generate printed output. The printing mechanism 132 may represent any type of printing mechanism. For example, the printing mechanism may be of a type that employs an electro-photographic (EP) process to generate printed output or of a type that employs inkjet technology.

The scanner mechanism 134 enables the MFP 104 to scan a printed document (such as printed credit card receipts as is described below) so as to produce electronic data that describes the document. The scanner mechanism 134 may represent, for example, a sheet-fed type scanner and/or a flatbed type scanner. The scanner mechanism 134 may include an image sensor (e.g., a charge-coupled device (CCD) array), a document illumination system (e.g., one or lamps) and an optics system (e.g., mirrors, filters, etc.). In some implementations, the scanner mechanism 134 may include a document feeder for moving the document that is being scanned relative to the image sensor. In other implementations the document being scanned remains stationary and the image sensor is moved relative to the document during scanning.

The MFP 104 further includes operating software 140 that is stored in the memory 122 and that is executable by the processor 120 to control the operation of the MFP 104. As shown, the operating software 140 includes a credit receipt tracking module 142 and a Web Server 144.

Generally speaking, the credit receipt tracking module 142 enables the MFP 104 to provide a user, such as the user 154, with the credit receipt tracking service. As is discussed in greater detail below, a user can make use of the credit receipt tracking service to record credits to one or more of his/her credit card accounts and to receive reports of these credits at pre-determined times. Thus, for example, the user 154 can use this service to record credits to each of his/her two credit card accounts 156b, 158b and to receive reports of these same credits. The user 154 can use these reports to track and reconcile credits to each of his/her two credit card accounts 156b, 158b.

To implement the credit receipt tracking service, the MFP 104 further includes a Web page 146, and a credit receipt database 148. The Web page 146, which is assigned a URL address, is shown stored in the memory 122 and provides a user (e.g., the user 154) of the host computer 108 a graphical user interface (GUI) for configuring the MFP 104 to record and report credits to one or more of the user's credit card accounts as is described further below. The MFP 104 (operating under the direction of the Web Server 144) can serve the Web page 146 to the host computer 108 in response to receiving an appropriate request from the host computer 108.

The credit receipt database 148 is used to hold electronic records of printed receipts of credits to the user's credit card accounts. These records may be physically stored in the MFP memory 122 as indicated in FIG. 1.

### MFP Configuration to Track User's Credit Card Credits

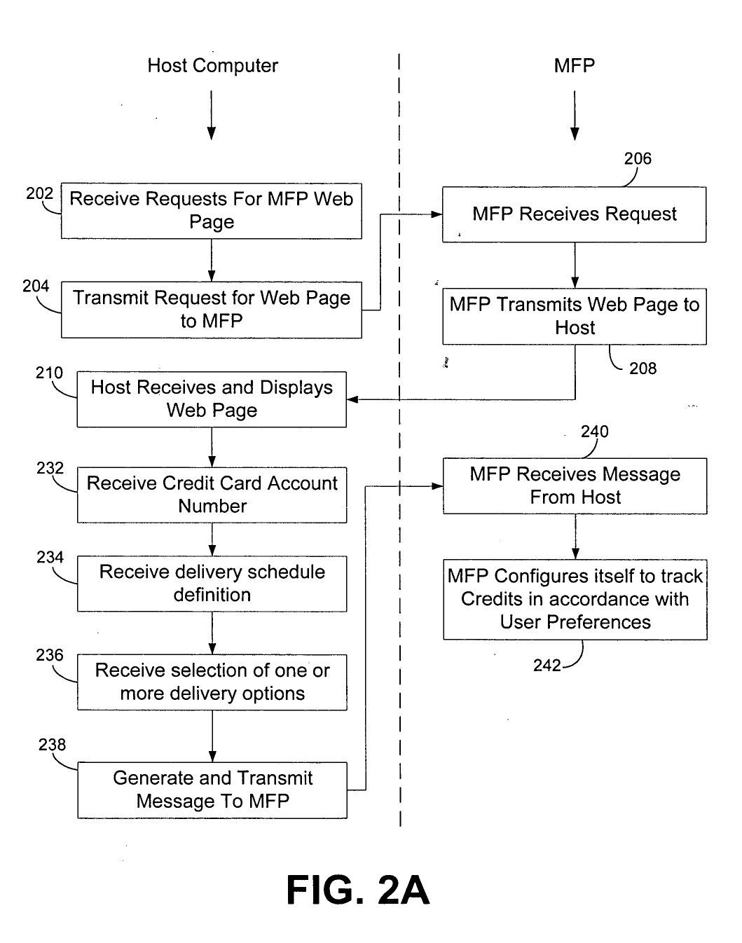

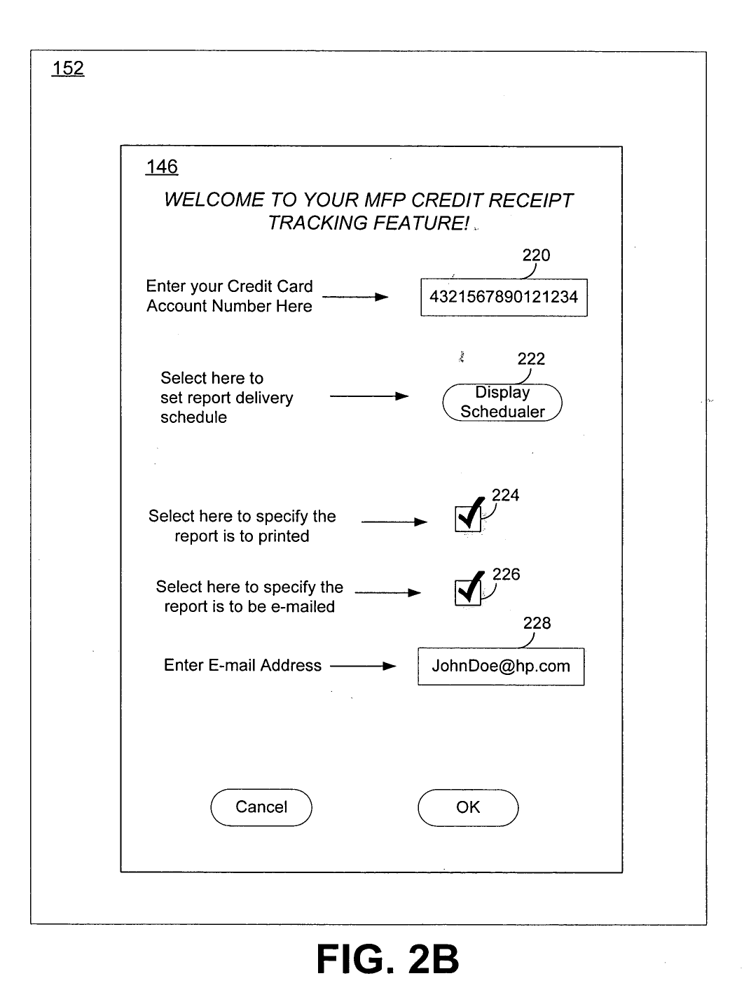

In view of the foregoing, reference is now made to FIG. 2A in which a flow chart is depicted describing how the user 154 may operate the host computer 108 to initially configure the MFP 104 to track credits to each of his/her two credit card accounts 156b, 158b.

Beginning at block 202, the user 154 interacts with the WEB browser 153 running on the host computer 108 to request the Web Page 146 from the MFP 104. This may involve the user providing input to the host computer 108 that specifies the URL address that is assigned to the Web page 146.

At block 204, the host computer 108 responds to the user request and transmits an electronic request, via the communication link 110, for the Web page 146 to the MFP 104.

At block 206 and block 208, the MFP 104 receives the request and in response transmits the Web page 146 to the host computer 108. It is noted that this aspect of the MFP 104 functionality may be enabled by the Web server 144.

At block 210, the host computer 108 receives and displays the Web page 146. As previously indicated, the Web page 146 provides a graphical user interface (GUI) that allows the user 154 to configure the MFP 104 to record and report credits to a particular credit card account.

FIG. 2b illustrates, by way of example, one non-limiting implementation of the Web page 146. As shown in FIG. 2B, the Web Page 146 may include a first user input field 220 that allows a user of the host computer 108 to input the credit card number (e.g., “4321567890121234”) of the credit card account he/she wishes the MFP 104 to begin tracking.

The WEB page 146 may also allow a user to define a delivery schedule for the MFP 104 to deliver a report of credits to the inputted credit card number. In order to define the delivery schedule, the user first selects an icon 222. In response to this selection, the Web page 146 displays a scheduler dialog box. The user can then interact with this dialog box to define the delivery schedule. In some embodiments, the dialog box may allow a user to define a delivery schedule in terms of a recurring pattern of time intervals over a particular range of time intervals. For example, the dialog box may allow a user to specify that he/she wishes the MFP 104 to deliver a report at 9:00 AM on the fifth day of every month for the next ten months. An example of a dialog box that allows a user to specify a recurring pattern of time intervals can be found in the book entitled OUTLOOK 2000 IN A NUTSHELL (ISBN 1-56592-704-4) at pages 292-293. These pages are incorporated herein by reference.

It is further noted that the Web page 146 may also allow a user to select various options with respect to how he/she wishes the MFP 104 to deliver the report. In this example, the Web page 146 allows a user to select a first option 224 to specify that the MFP 104 is to deliver the credit report by printing it. In addition, the user may select a second option 226 to specify that he/she wishes the MFP 104 to e-mail the report to a particular e-mail address. If the user selects the second option 226, the user can input the e-mail address into user input field 228. In the example, shown, the user has indicated he/she wishes the report to be both printed and e-mailed to “johndoe@hp.com”.

Reference is again made to FIG. 2A, wherein at block 232 the user 154 interacts with the displayed Web Page 146 to input the credit card number of the credit card he/she wishes the MFP 104 to begin tracking. In this example, we will assume the user 154 inputs the credit card number of his/her first credit card account 156b.

At block 234, the user 154 further interacts with the displayed Web Page 146 to define a delivery schedule for the MFP 104 to deliver a report of credits for the first card account 156b. In this example, we will assume the user 154 interacts with the Web Page 146 to specify that the MFP 104 is to deliver a report of credits to the first credit card account 156b at 9:00 AM on the tenth day of every month for the next 10 months. This recurring date and time may be specified by the user 154 to coincide, for example, with his/her expected receipt of a monthly statement for the first credit card account 156b from the first credit card provider 156c.

At block 236, the user 154 selects how he/she wishes the MFP 104 to deliver the credit report for the first credit card account 156b. In this example we will assume that the user 154 specifies that he/she wishes the MFP 104 to deliver the report by printing it and by e-mailing it to his/her e-mail address.

At block 238, the host computer 108 generates and transmits a message back to the MFP 104 that specifies the user input described above.

At block 240, the MFP 104 receives the message. At block 242, the MFP 104 responds to the message by configuring itself to track credits to the first credit card account 156b in accordance with the user preferences as specified by the message. The MFP 104 may, at block 242, generate a configuration file that specifies the credit card number inputted by the user at block 232 as well as the report delivery schedule (defined by the user at block 234) and user selected report delivery options (defined by the user at block 236).

The user 154 may then follow a similar procedure to configure the MFP 104 to track credits to his/her second credit card account 158b.

### Credit Receipt Processing

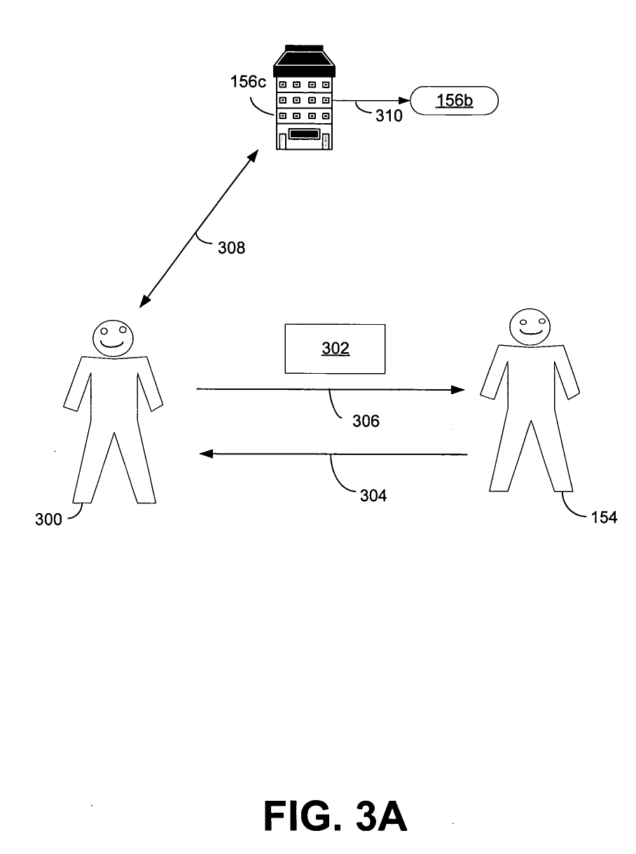

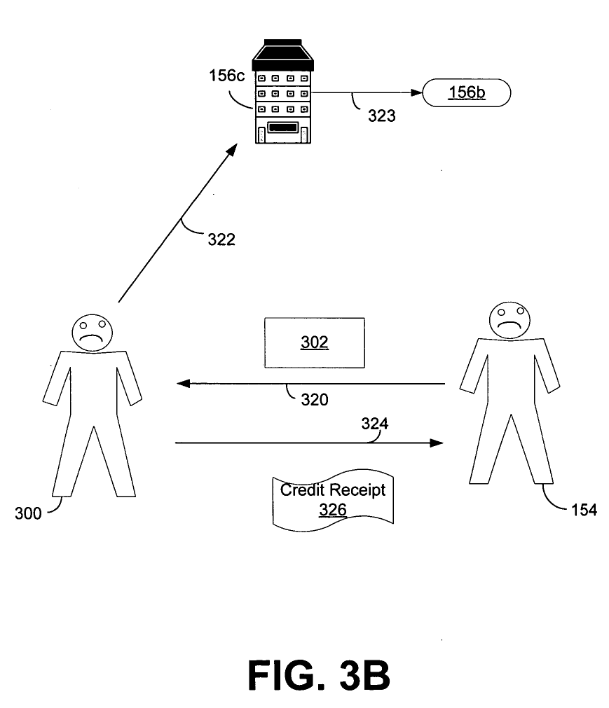

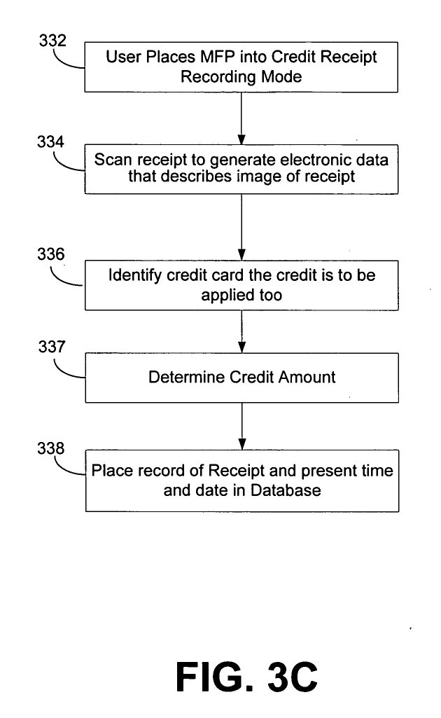

Reference is now made to FIG. 3A-3C, in which a specific example is depicted as to how the user 154 may receive a credit receipt and then use the MFP 104 to create a record of the credit receipt.

Referring first to FIG. 3A, we will assume in the following discussion that the user 154 initially interacts with a merchant 300 to purchase a merchandise item 302 and that the user 154 uses his/her first credit card 156a to make this purchase. This particular transaction is represented by the three arrows shown in the figure.

The first arrow 304 represents the authorization provided by the user 154 to the merchant 300 to charge the use's first credit card account 156b the purchase price of the merchandise item 302. The second arrow 306 represents the merchant 300 providing the user 154 with the merchandise item 302.

The third arrow 308 represents the merchant 300 interacting with the user's credit card provider 156c to obtain the funds for the user's purchase of the merchandise item 302. The credit card provider 156 provides these funds to the merchant 300 and places a charge (as represented by the fourth arrow 310) for these funds on the user's credit card account 156b. This charge would be subsequently reflected on a monthly statement provided by the credit card provider 156c to the user 154.

Referring next to FIG. 3B, we further assume that the user 154 later interacts with the merchant 300 to return the merchandise item 302 for a credit to his/her credit card account 156b. The first arrow 320 represents the merchant receiving the merchandise item 302 back from the user 154. The second arrow 322 represents the merchant 300 transacting with the credit card provider 156c to apply for a credit to the user's credit account 156b. The third arrow 323 represents the credit card provider 156c applying this credit to the user's credit card account 156b.

The fourth arrow 324 represents the merchant 300 providing a printed credit receipt 326 to the user 154 of this credit. The credit receipt 326 typically would list at least a portion of the credit card number (e.g., the last four digits) of the credit card 156a and the amount of the credit that is to be (or was) applied to the user's credit card account 156b.

Reference is now made to FIG. 3C in which a flow diagram is depicted for illustrating how the user 154 may subsequently use the MFP 104 to place a record of the printed credit receipt 326 in the credit receipt database 148.

Beginning at block 332, the user 154 approaches the MFP 104 with the credit receipt 326 and interacts with the local user interface 130 to place the MFP 104 into a “credit receipt recording mode” of operation. While operating in this mode, the MFP 104 is enabled to perform the rest of the acts depicted in FIG. 3C.

At block 334, the user 154 further interacts with the MFP 104 to cause it to scan the printed credit receipt 326. This results in the MFP 104 generating electronic data that describes an image of the printed receipt 326. The electronic data may be in accordance with a Portable Document Format (PDF), for example.

At block 336, the MFP 104 identifies the particular credit card that the MFP is presently tracking that the credit belongs too. Thus, the MFP 104 determines, in this instance, that the printed credit receipt 326 lists a credit that is to be applied to the first credit card 156a.

This act may be accomplished in a number of different ways. For example, the MFP 104 may prompt the user via the local user interface 130 to identify the credit card by inputting the card number. The user may respond to this prompt by inputting the credit card number of the first credit card 156a at the local user interface 130.

Alternatively, the MFP 104 may use optical character recognition functionality to automatically identify the credit card number (or the portion of the credit card number) that is listed on the receipt. Thus, the MFP 104, under the direction of the credit receipt tracking module 142, may process the electronic data generated at block 334 in accordance with one or more image processing algorithms to detect the credit card number (or the portion of the credit card number) that is listed on the credit receipt 326. The MFP 104 may then compare this information to the known credit card numbers that are presently being tracked by the MFP 104 in order to determine that the present credit is to be applied to the first credit card 156a.

At block 337, the MFP 104 determines the credit amount indicated by the printed credit receipt 326. This act may also be accomplished in a number of different ways. For example, the MFP 104 may prompt the user via the local user interface 130 to input the credit amount. The user may respond to this prompt by inputting the credit amount at the local user interface 130. Alternatively, the MFP 104 could use optical character recognition functionality to determine the credit amount directly from the credit receipt 326. Thus, the MFP 104, under the direction of the credit receipt tracking module 142, may process the electronic data generated at block 334 in accordance with one or more image processing algorithms to determine the credit amount.

At block 338, the MFP 104 proceeds to place a record of the credit receipt 326 in the receipt database 148. The record may specify the credit card number of the credit card identified at block 336, the credit amount determined at block 337, and the date and time the receipt 326 was recorded. The record may also include the electronic data that describes the image of the credit receipt 326.

The user 154 may further interact with the MFP 140 in a similar manner to place records of additional credit receipts for credits to each of his/her two credit card accounts 156b, 158b presently being tracked by the MFP 104.

### Credit Report Delivery

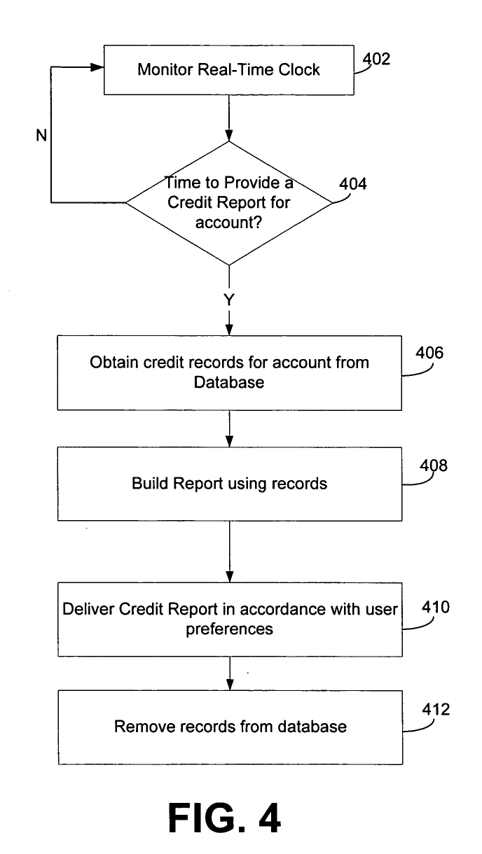

Reference is now made of FIG. 4 in which a flow chart is shown that depicts how the MFP 104 may operate to deliver a report to the user 154 of credits to either the first credit card account 156b or the second credit card account 158b.

At block 402, the MFP 104 monitors the real-time clock 126 to determine the present time and date.

At block 404, the MFP 104 determines if it is time, based upon the user defined report delivery schedule, to deliver a report of credits for one of the user's two credit cards 156a, 158a.

Upon determining that it is time to deliver a report for a particular credit card, the MFP 104 obtains the records for this account from the credit receipt database 148 (block 406).

At block 408, the MFP builds a report using the retrieved records. The report may include an image of each credit receipt specified by the retrieved records as well as the credit amount listed on each credit receipt. The report may also indicate the time and date each of these credit receipts were recorded.

Thus, for example, if the report being generated is for the first credit card account 156b, the report may include an image of the credit receipt 326, the credit amount (as determined at block 337), as well as the time and date the credit receipt 326 was recorded by the MFP 104.

At block 410, the MFP delivers the report in accordance with the user's preferences. Thus, in this example, the MFP 104 may print the report and/or e-mail it to an e-mail address specified by the user 154.

After delivering the report, at block 412, the MFP 104 may then permanently remove the records included in the report from the database 148.

The user 154 can then retrieve the report (e.g., by accessing his/her e-mail account and/or by picking up the printed version of the credit report at the MFP 104) and may then use the report to, for example, reconcile credits listed on his/her monthly statement for the corresponding credit card account.

It is further noted that the present invention may be embodied in the form of a “computer-readable medium”. As used herein, the phrase “computer readable medium” can refer to any medium that can contain, store or propagate computer executable instructions. Thus, in this document, the phrase “computer-readable medium” may refer to a medium such as an optical storage device (e.g., a CD ROM) or a magnetic storage device (e.g., a magnetic tape). The phrase “computer-readable medium” may also refer to signals that are used to propagate the computer executable instructions over a network or a network system, such as the Public Internet.

Thus, a memory component (e.g., the MFP memory 122) that stores computer executable instructions (e.g., the credit receipt tracking module 148) may represent an embodiment of the invention. Furthermore, signals used to propagate the firmware over a communication link (e.g. an intranet, Public Internet, etc.) may also represent an embodiment of the invention.

Although several specific embodiments of the invention have been described and illustrated, the invention is not to be limited to specific forms or arrangements of parts so described and illustrated. The invention is limited only by the claims and the equivalents thereof.

What is claimed is:

1. In a multifunctional peripheral (MFP) including a scanner mechanism, a method of delivering a report to a user comprising:
(a) generating, by use of the scanner mechanism, electronic data that describes an image of a receipt, where the receipt indicates a credit amount to a credit card account; and
(b) automatically delivering a report of the credit to a user of the MFP.

2. The method of claim 1, wherein the delivering step is performed at a pre-determined time.

3. The method of claim 1, further comprising:
(c) receiving input from the user that defines a report delivery schedule; and
(d) wherein the delivering act is performed in accordance with the delivery schedule.

4. The method of claim 1, further comprising:
(c) receiving a message from a host computer, where the message specifies a delivery schedule;
(d) wherein the delivering act is performed in accordance with the delivery schedule.

5. The method of claim 1, further comprising:
(c) receiving a message that indicates the report is to be delivered in accordance with a recurring time interval;
(d) wherein the delivery act is performed at the next recurring time interval immediately following the generating act.

6. The method of claim 1, further comprising:
receiving user input that specifies the report is to be delivered by printing it; and
wherein the delivering step is performed, at least in part, by printing the report.

7. The method of claim 1, further comprising:
receiving user input that specifies the report is to be e-mailed to a specific e-mail address; and
wherein the delivering step is performed, at least in part, by e-mailing the report to the e-mail address.

8. The method of claim 1, further comprising:
receiving user input that specifies the report is to be both e-mailed to a specific e-mail address and printed;
wherein the delivering step is performed by both e-mailing the report to the e-mail address and by printing it.

9. The method of claim 1, further comprising:
receiving, from a host computer, a request for a graphical user interface (GUI);
providing the host computer with the GUI; then receiving a message from the host computer that indicates a user defined delivery schedule; and
wherein the GUI enables a user of the host computer to define the delivery schedule; and
wherein act (b) is performed in accordance with the delivery schedule.

10. The method of claim 1, further comprising:
(c) processing the electronic data to identify a credit card that corresponds to the credit card account; and
(d) processing the electronic data to determine the credit amount; and
wherein the report identifies the credit card and the credit amount.

11. The method of claim 1, further comprising:
prior to performing the generating step, causing a host computer connected to the MFP to display at least one WEB page that enables a user of the host computer to define a delivery schedule of the report and also to select whether the report is to be e-mailed or printed or both.

12. The method of claim 1, further comprising:
prior to performing the generating step, causing a host computer connected to the MFP to display a GUI that enables a user of the host computer to define a delivery schedule of the report and also to select whether the report is to be e-mailed or printed or both;
receiving a message from the host computer that indicates a user defined delivery schedule and a user selection as to whether the report is to be e-mailed or printed or both;
wherein the report is delivered at step (b) in accordance with the user defined delivery schedule;
wherein if the message indicates the user selected the report is to be printed, step (b) is performed by printing the report; and
wherein if the message indicates the user selected the report is to be e-mailed, step (b) is performed by e-mailing the report.

13. The method of claim 1, wherein the report includes an image of the receipt.

14. A method of providing a report to a user, comprising:
under the control of an multi-functional peripheral (MFP) connected to a host computer,
receiving, from the host computer, a message that identifies a credit card, where the credit card corresponds to a credit card account;
generating, by a use of a scanner mechanism incorporated within the MFP, electronic data that describes an image of a printed receipt that indicates a credit amount has been applied to the credit card account;
automatically delivering a report to a user, wherein the report includes an image of the printed receipt.

15. The method of claim 14, wherein the message further includes a delivery schedule for the report; and
wherein the delivering step is performed in accordance with the delivery schedule.

16. The method of claim 14, wherein the message indicates a delivery schedule;
wherein the message further indicates the report is to be delivered to a particular e-mail address;
wherein the delivering step is performed at a time that is in accordance with the delivery schedule;
wherein the report is delivered by e-mailing the report to the e-mail address.

17. The method of claim 14, wherein the delivery schedule is defined by a user to coincide with an arrival of a monthly statement for the credit card account.

18. The method of claim 14, further comprising:
placing a record in a database, wherein the record specifies the credit amount and also includes data that describes an image of the report;
building the report using the record.

19. A multifunctional peripheral (MFP), comprising:
a scanner mechanism;
a print mechanism for printing documents;
a control system connected the scanner mechanism and the print mechanism;
a database for holding records of credit receipts;
wherein the control system is configured to control the scanner mechanism to scan a receipt of a credit to a credit card account so as to generate electronic data that describes the receipt; and
wherein the control system is further configured to automatically place a record of the receipt in the database.

20. The MFP of claim 19, wherein the MFP is further configured to deliver a report of the credit in accordance with a user determined delivery schedule.

21. A multifunctional peripheral (MFP), comprising:
a scanner mechanism;
a print mechanism for printing documents;
a control system to control the operation of the scanner mechanism and the print mechanism, and where the control system is programmed to provide a credit receipt tracking service;
a database that is dedicated for holding records of a user's credit receipts.

22. The MFP of claim 21, wherein the control system is configured to control the scanner mechanism to scan a receipt of a credit to a credit card account so as to generate electronic data that describes the receipt; and
wherein the control system is further configured to automatically generate a record of the credit and to place the record in the database.

23. The MFP of claim 22, wherein the control system is further configured to automatically create and deliver a report that indicates the credit.

24. The MFP of claim 23, wherein the control system is further configured to receive input from a user that defines a delivery schedule for the report.

25. The MFP of claim 23, wherein the control system is further configured to automatically print a report of the credit at a user defined pre-determined time.

26. The MFP of claim 23, wherein the control system is further configured to automatically e-mail the report to a user defined e-mail address at a user defined time.

27. A multifunctional peripheral (MFP) that includes both scanning and printing functions, comprising:
means for scanning a first plurality of credit receipts each indicating a credit amount and a portion of a first credit card number;
means for automatically delivering, to a user, a first report that provides each credit amount indicated by each of the first plurality of credit receipts.

28. The MFP of claim 27, further comprising:
means for scanning a second plurality of credit receipts each indicating a credit amount and a portion of a second credit card number;
means for automatically delivering, to a user, a second report that provides each credit amount indicated by the second plurality of credit receipts.

29. The MFP of claim 28, wherein the means for delivering the first report operates to deliver the first report in accordance with a first user defined delivery schedule; and
wherein the means for delivering the second report delivers the second report in accordance with the second user defined delivery schedule.

30. The MFP of claim 29, wherein the first credit card number is different than the second credit card number.

31. The MFP of claim 29, wherein the first user defined deliver schedule is different than the second user defined delivery schedule.

32. The MFP of claim 28, further comprising:
means for the providing the user with a graphical user interface that allows the user to select at least one option with respect to how the MFP is deliver the first report.

33. One or more computer-readable media containing computer-executable instructions that, when executed by a multifunctional peripheral (MFP) that includes a scanning function and a printing function, perform the following steps:
placing a first record of a scanned credit receipt in a database, where the credit receipt indicates a credit amount and where the record specifies the credit amount;
at a pre-determined time, retrieving the record from the database; and
delivering a report to a user that indicates the credit amount specified by the retrieved record.

34. In a host computer connected to a MFP that includes a credit tracking feature, a method, comprising:
(a) displaying, on the host computer, a graphical user interface that allows a user of the host computer to:
(i) identify a credit card that the user wishes the MFP to begin tracking, and
(ii) define a delivery schedule of a report of credits to the credit card.

35. The method of claim 34, further comprising:
(b) receiving, by the host computer, user input that identifies a credit card;
(c) receiving, by the user computer, user input that defines a delivery schedule;
(d) transmitting, by the host computer, to the MFP a message that indicates the user input received at step (b) and at step (c); and
wherein the MFP is responsive to the message.
